(19) United States
(12) Patent Application Publication
(10) Pub. No.: US 2005/0238416 A1
(43) Pub. Date: Oct. 27, 2005

(54) File folder having cover retaining device

(76) Inventor: Jui Yang Chang, Taichung (TW)

Correspondence Address: Jui Yang Chang, P.O. Box 63-298, Taichung, Taiwan 406, TW

(21) Appl. No.: 10/830,892

(22) Filed: Apr. 22, 2004

(51) Int. Cl. B42D 1/00

(52) U.S. Cl. 402/75

(57) ABSTRACT

A file folder includes a cover panel having one or more notches, a base panel foldably coupled to the cover panel with a coupling panel, to allow the base panel and the cover panel to be folded relative to the coupling panel. A binder device is attached to the base panel, and includes one or more binding members each having an upper portion extendible into the notch of the cover panel, and engageable with the cover panel, to sustain the cover panel relative to the base panel. The cover panel includes a projection extended into each of the notches and engageable into the binding members, to anchor the binding members to the cover panel, and to openably retain the cover panel to the base panel.

### BACKGROUND OF THE INVENTION

1. Field of the Invention

The present invention relates to a file folder, and more particularly to a file folder having a retaining or locking device or structure to detachably retaining or locking a cover panel to a base panel the file folder.

2. Description of the Prior Art

Various kinds of typical file folders or binder devices or organizers have been developed and comprise a base panel and a cover panel foldable relative to each other, and a loose leaf binder device attached to the base panel, for attaching or retaining sheet members between the base panel and the cover panel.

For example, U.S. Pat. No. 5,704,646 to Tzeng discloses one of the typical file folders or binder devices or organizers and also comprises a loose leaf binder device attached to the base panel, for attaching or retaining sheet members between the base panel and the cover panel.

For allowing the base panel and the cover panel to be locked together and to prevent the cover panel to be opened relative the base panel inadvertently, the cover panel includes a longitudinal flange extended therefrom and having a female retainer attached thereto for engaging with a male retainer that is attached to the base panel, to lock the base panel and the cover panel together. However, the longitudinal flange may not be extended or attached to the file holders having hard base panel and/or hard cover panel.

U.S. Pat. No. 6,213,669 to Yamamoto discloses another typical file folder or binder device or organizer comprising a zipper for openably securing a base panel and a cover panel together, and a loose leaf binder device attached to the base panel, for attaching or retaining sheet members between the base panel and the cover panel, or within the file folder or binder device or organizer.

However, the zipper also may not be easily attached to the file holders having hard base panel and/or hard cover panel.

The present invention has arisen to mitigate and/or obviate the afore-described disadvantages of the conventional file folders.

### SUMMARY OF THE INVENTION

The primary objective of the present invention is to provide a file folder including a retaining or locking device or structure to detachably retaining or locking a cover panel to a base panel of the file folder, and to prevent the cover panel from being opened relative the base panel inadvertently.

In accordance with one aspect of the invention, there is provided a file folder comprising a cover panel including at least one notch formed therein, a base panel, a coupling panel disposed between and foldably coupled between the cover panel and the base panel, to allow the base panel and the cover panel to be folded relative to the coupling panel, and a binder device attached to the base panel, and including at least one binding member provided thereon, the binding member include an upper portion extendible into the notch of the cover panel, and engageable with the cover panel, to sustain the cover panel relative to the base panel.

The cover panel includes a projection extended into the notch of the cover panel, and engageable into the binding member, to anchor the binding member to the cover panel, and to openably retain the cover panel to the base panel.

The cover panel includes a first flap foldably extended from a free edge thereof, and having at least one opening formed therein for carrying purposes. The first flap includes at least one fastener attached thereto.

The base panel includes a second flap foldably extended from a free edge thereof, and having at least one opening formed therein for carrying purposes, the second flap is superposeable with the first flap. The second flap includes at least one fastener attached thereto and engageable with the fastener of the first flap, to detachably secure the first flap and the second flap together.

The second flap includes at least one second opening formed therein for hanging purposes. The first flap includes at least one second opening formed therein for hanging purposes. The coupling panel includes at least one orifice formed therein for carrying purposes.

The base panel includes a coupling strip and an outer flap foldably extended from a free edge thereof. The outer flap includes at least one notch formed therein, to partially receive the upper portion of the binding members.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a file folder in accordance with the present invention;

FIG. 2 is a perspective view showing a number of file folders that are superposed or stacked together;

FIG. 3 is a cross sectional view of the file folder, taken along lines 3-3 of FIG. 2;

FIGS. 4, 5 are perspective views illustrating the operation of the file folder;

FIG. 6 is a perspective view illustrating another embodiment of the file folder;

FIG. 7 is a cross sectional view of the file folder as shown in FIG. 6;

FIG. 8 is a perspective view illustrating a further embodiment of the file folder;

FIG. 9 is a cross sectional view of the file folder as shown in FIG. 8;

FIG. 10 is a perspective view illustrating a still further embodiment of the file folder which is in an open status;

FIG. 11 is a perspective view of the file folder as shown in FIG. 10, which is in a closed status;

FIG. 12 is a cross sectional view of the file folder as shown in FIGS. 10, 11;

FIGS. 13, 14 are perspective views illustrating the operation of the file folder as shown in FIGS. 10-12;

FIG. 15 is a perspective view illustrating a still further embodiment of the file folder which is in an open status;

FIG. 16 is a cross sectional view of the file folder as shown in FIG. 15;

FIG. 17 is a perspective view illustrating a still further embodiment of the file folder which is in an open status;

FIG. 18 is a cross sectional view of the file folder as shown in FIG. 17;

FIG. 19 is a perspective view illustrating a still further embodiment of the file folder which is in an open status;

FIG. 20 is a cross sectional view of the file folder as shown in FIG. 19;

FIG. 21 is a perspective view illustrating a still further embodiment of the file folder which is in an open status;

FIG. 22 is a cross sectional view of the file folder as shown in FIG. 21;

FIG. 23 is a perspective view illustrating a still further embodiment of the file folder which is in an open status;

FIG. 24 is a cross sectional view of the file folder as shown in FIG. 23.

### DETAILED DESCRIPTION OF THE PREFERRED EMBODIMENT

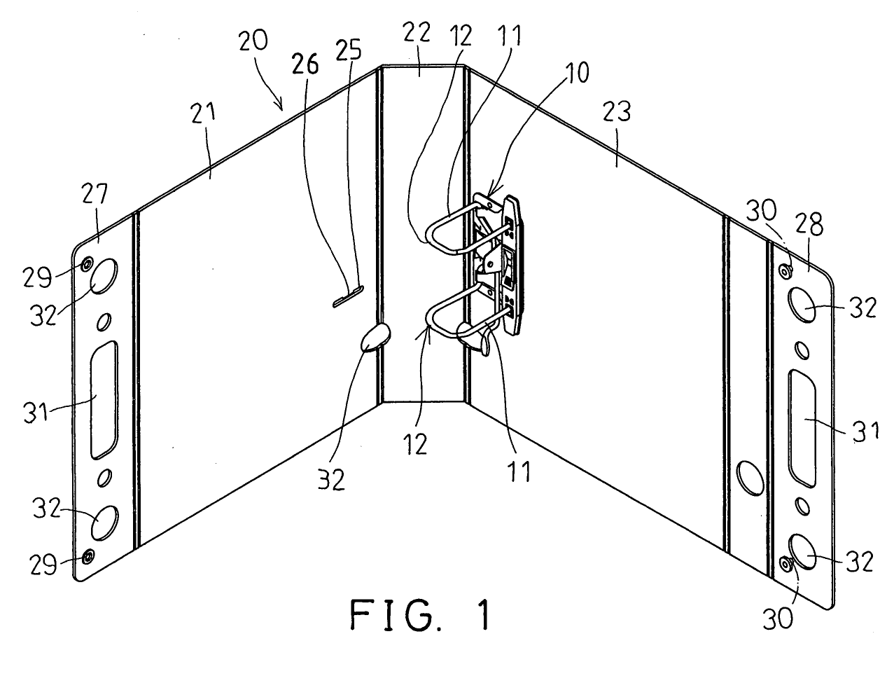

Referring to the drawings, and initially to FIGS. 1-4, a file folder 20 in accordance with the present invention comprises a cover panel 21 and a base panel 23 foldably coupled together with a coupling panel 22 that is disposed or arranged between the cover panel 21 and the base panel 23. The base panel 23 or the cover panel 21, such as the cover panel 21 includes one or more, such as two notches 25 formed therein, and a projection 26 extended into each of the notches 25 of the cover panel 21.

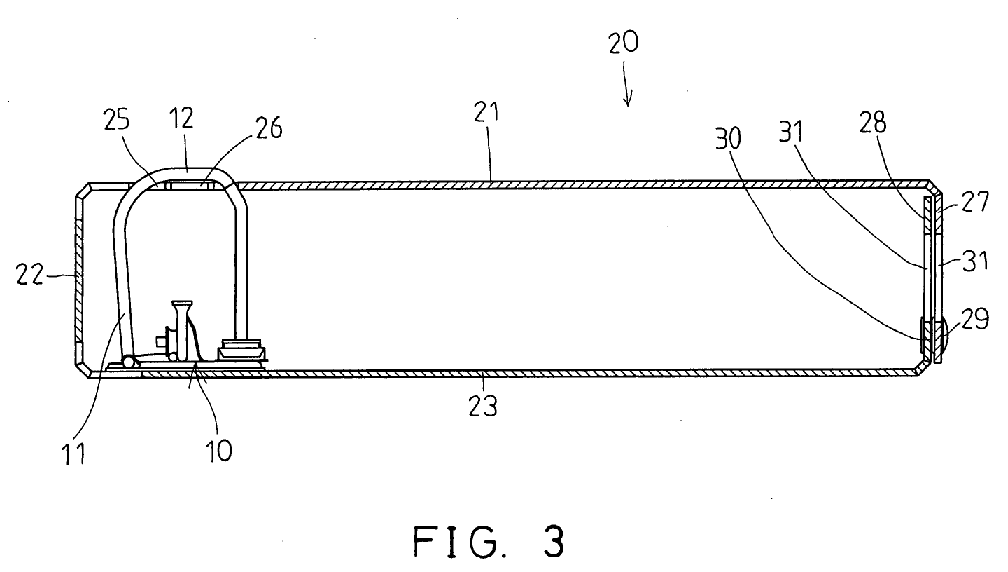

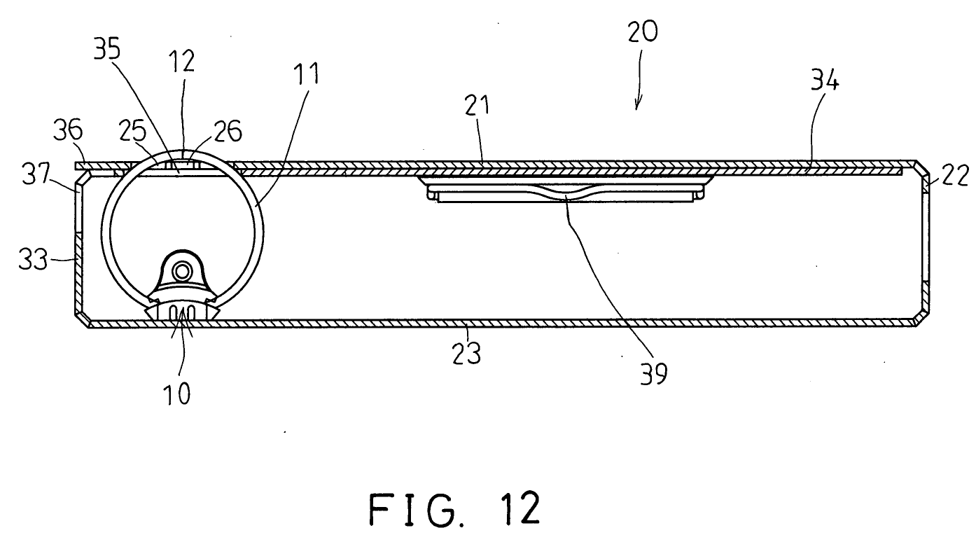

A binder device 10 is attached to either the cover panel 21 or the base panel 23, such as the base panel 23, and located close to the coupling panel 22, and includes one or more, such as two binding rings or members 11 disposed or provided thereon. The binding rings or members 11 include a portion, such as an upper portion 12 extendible into or through the corresponding notches 25 of the cover panel 21, and engageable with the cover panel 21, as shown in FIGS. 3, 7, 9, 12, to sustain or retain the cover panel 21 in parallel to the base panel 23.

As best shown in FIGS. 3, 7, 9, 12, 16, 18, 20, 22, 24, the binding rings or members 11 include a height greater than that of the coupling panel 22, and include a width or length greater than that of the notches 25 of the cover panel 21, to prevent the binding rings or members 11 from being completely engaged through the corresponding notches 25 of the cover panel 21, and to allow only the upper portions 12 of the binding rings or members 11 to extend into the corresponding notches 25 of the cover panel 21.

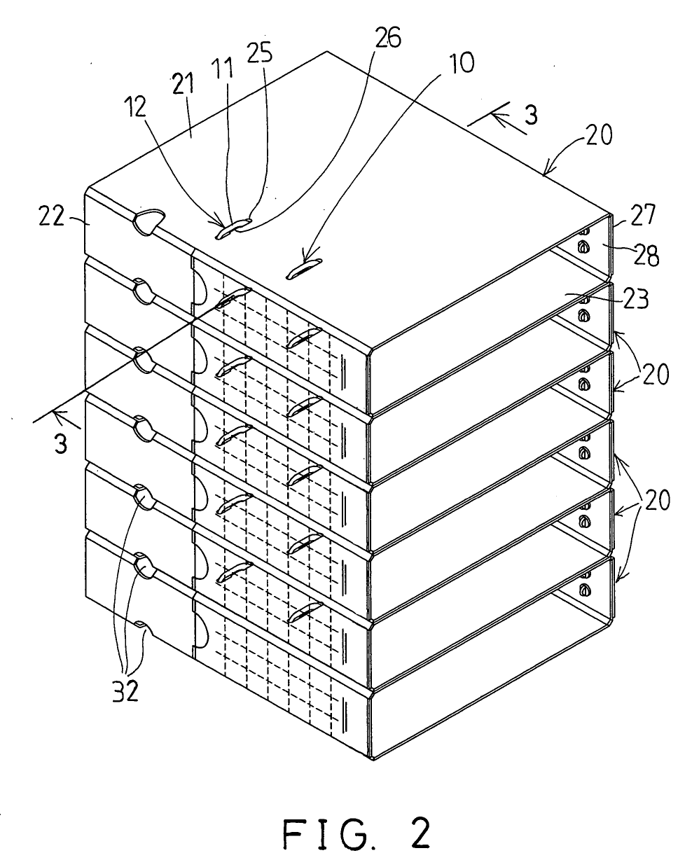

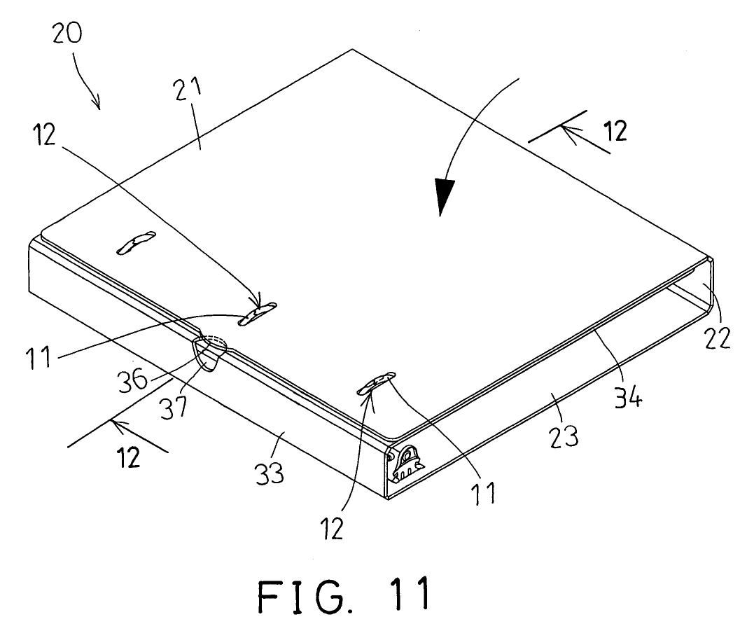

In addition, the projections 26 of the cover panel 21 are arranged to engage into the corresponding binding rings or members 11, best shown in FIGS. 2, 4, 5, 11, 13, to anchor the binding rings or members 11 to the cover panel 21, and thus to detachably or openably retain the cover panel 21 to the base panel 23, and to prevent the cover panel 21 from being opened relative to the base panel 23 inadvertently.

The file folder 20 may further include a flap 27, 28 foldably coupled to or extended from free edges of the cover panel 21 and the base panel 23 respectively, and one or more buttons or latches or fasteners 29, 30 attached to each of the flaps 27, 28. The flaps 27, 28 may be superposed with each other, as shown in FIGS. 2-4, and the fasteners 29, 30 may be engaged with each other, to sustain or retain the cover panel 21 in parallel to the base panel 23, and to retain the file folder 20 in a parallelepiped configuration.

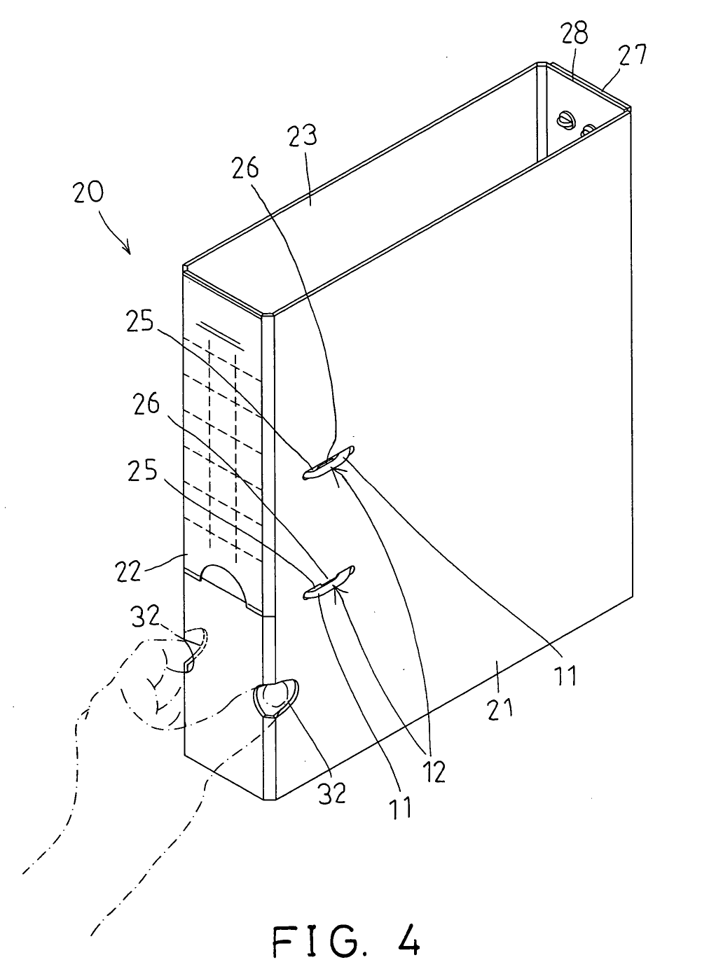

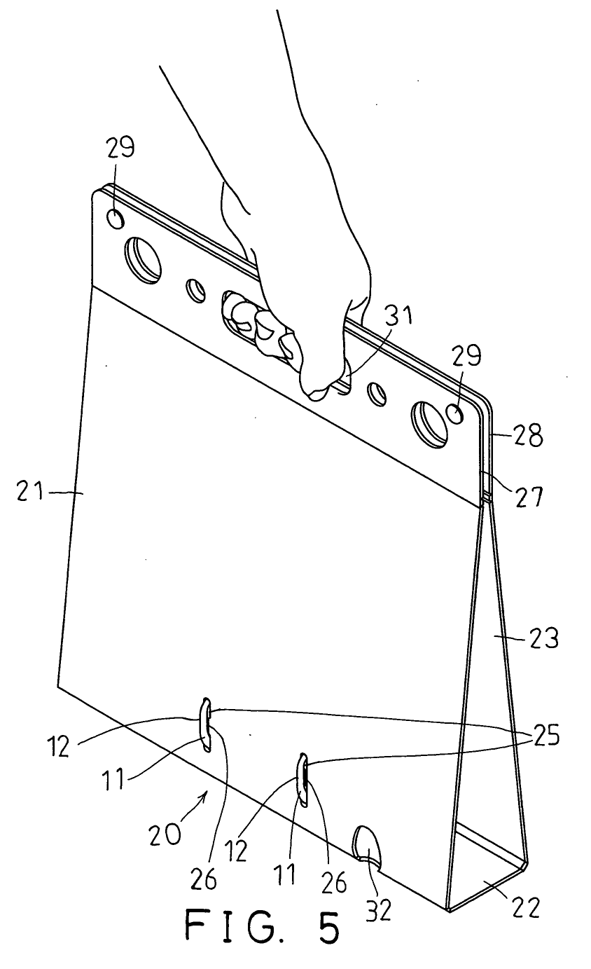

Each of the flaps 27, 28 may further include one or more openings 31, 32 formed therein, for allowing the file folder 20 to be easily carried with the users (FIG. 5), or to be hung on walls or the like with sustaining pegs (not shown) or the like. The file folder 20 may further include one or more orifices 32 formed therein, such as formed in the coupling panel 22 and/or the cover panel 21 and/or the base panel 23, to allow the file folder 20 to be easily carried with or grasped by the users (FIG. 4).

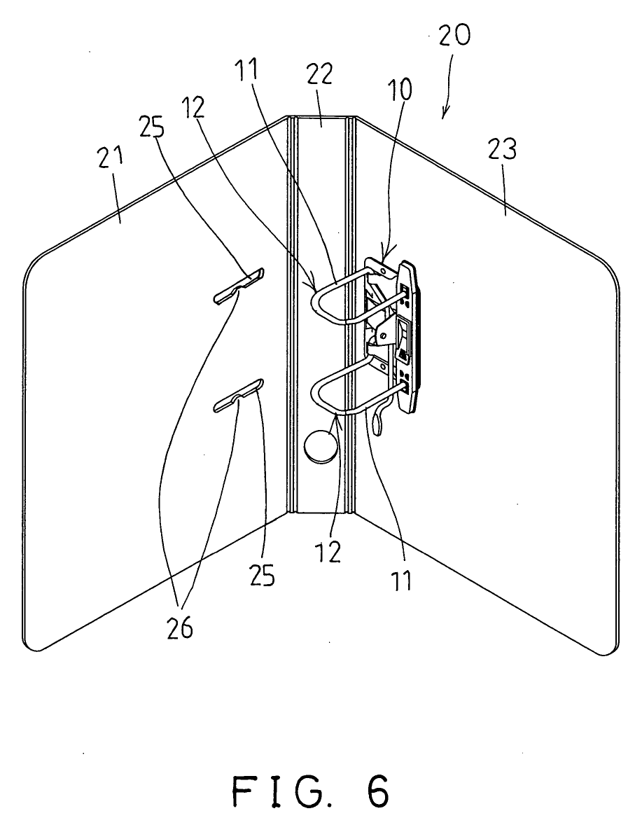

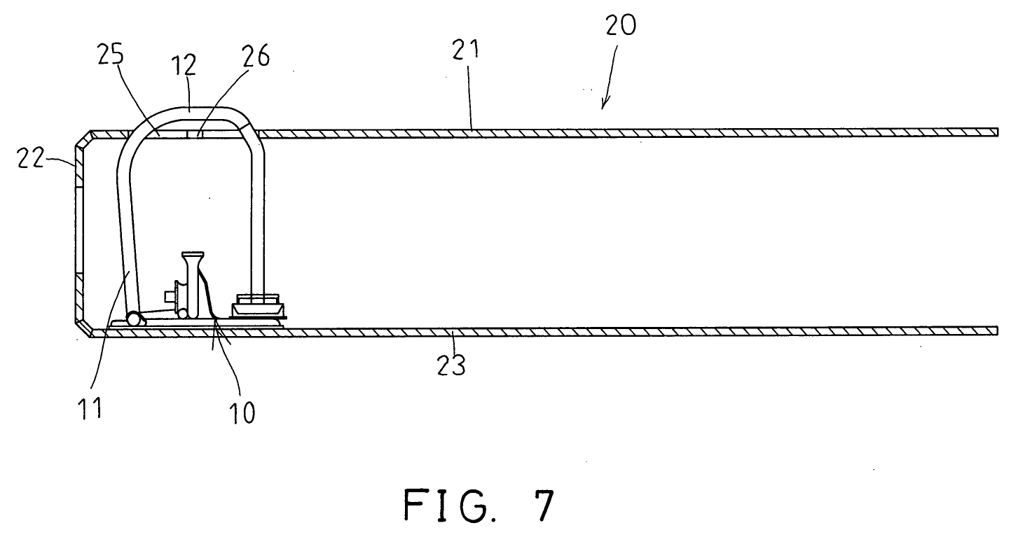

As shown in FIGS. 6-7, illustrated is another embodiment of the file folder 20, in which no flap 27, 28 are coupled to or extended from the cover panel 21 and the base panel 23. The cover panel 21 may also be sustained or retained in parallel to the base panel 23 by the extending of the upper portion 12 of the binding rings or members 11 into or through the corresponding notches 25 of the cover panel 21, and with the engagement of the binding rings or members 11 with the cover panel 21.

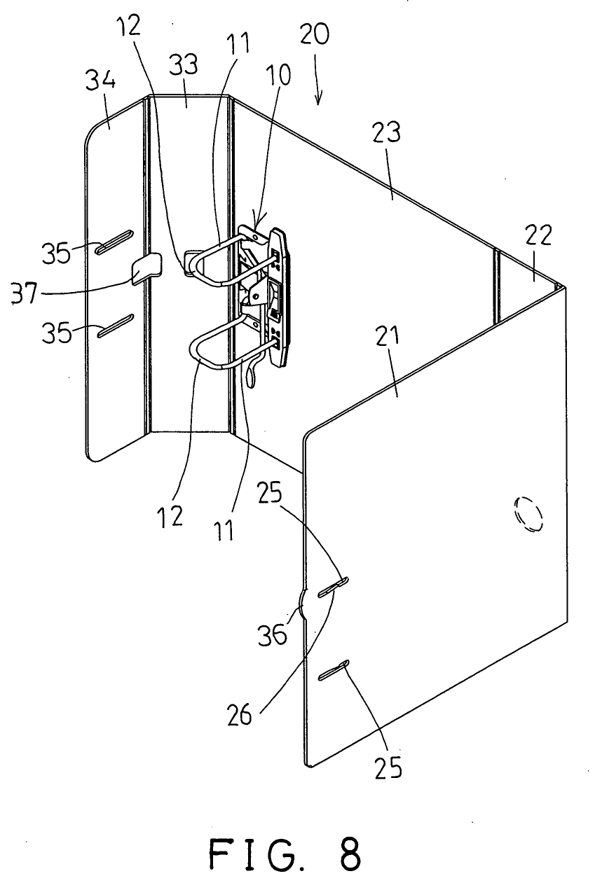

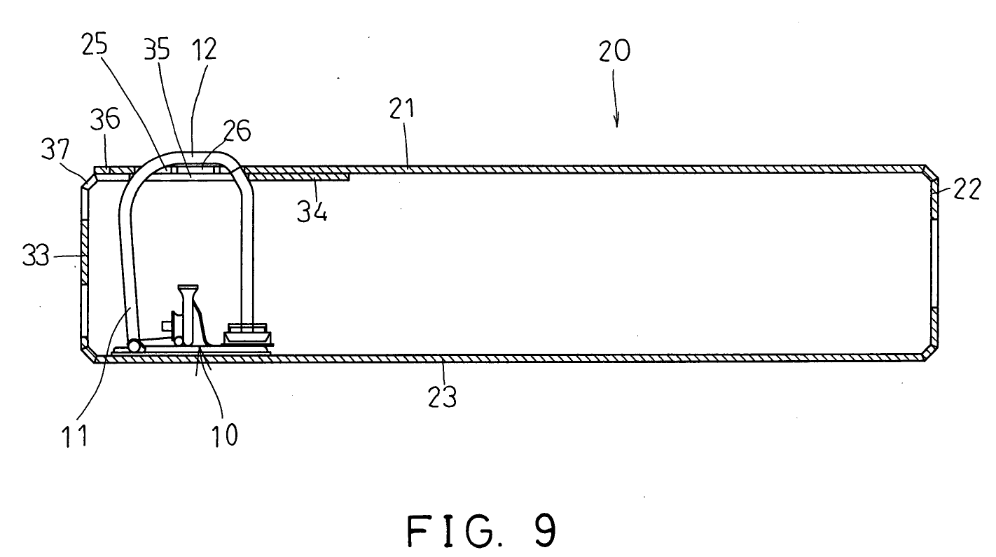

As shown in FIGS. 8-9, illustrated is a further embodiment of the file folder 20, in which the binder device 10 is attached to the base panel 23, and located distal to the coupling panel 22 and the cover panel 21, and the cover panel 21 also includes one or more notches 25 and projections 26 formed or provided therein, to engage with the binding rings or members 11.

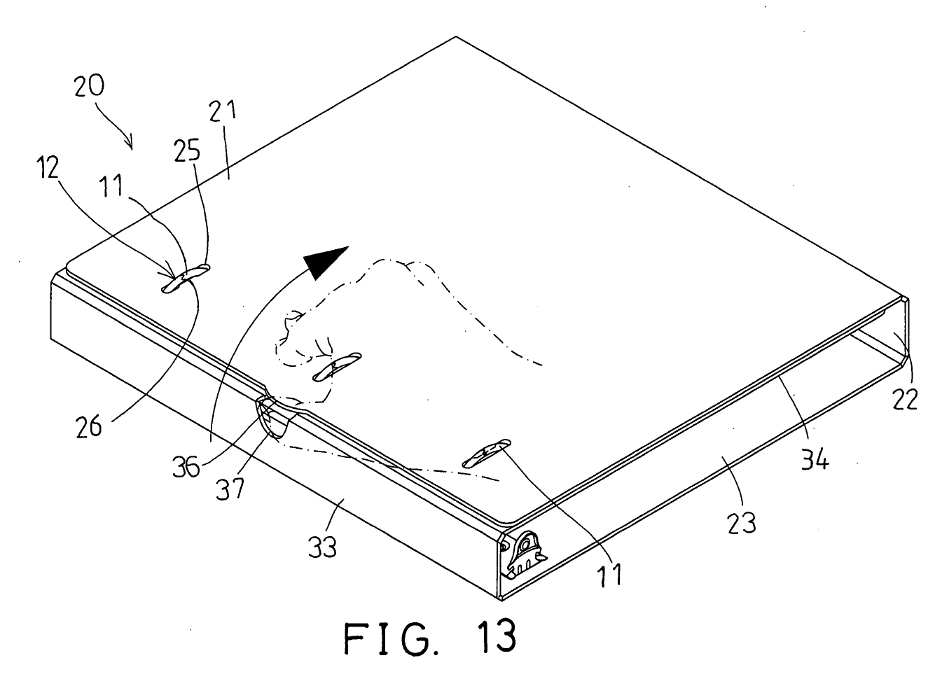

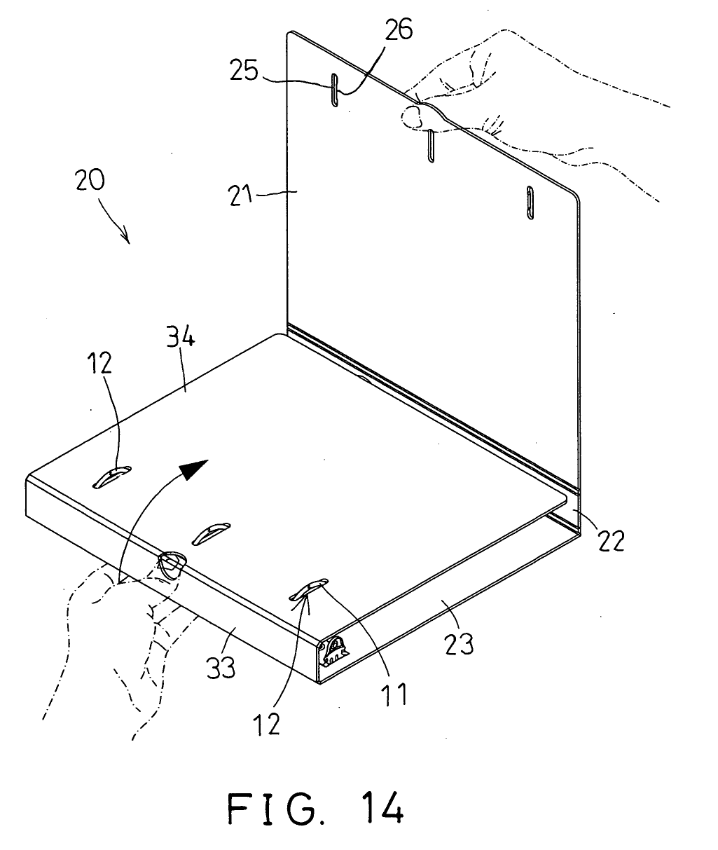

The base panel 23 further includes a coupling strip 33 and an outer flap 34 foldably coupled to or extended from the free edge of the base panel 23, and located distal to the coupling panel 22 and the cover panel 21, and foldable or engageable onto the binding rings or members 11. The outer flap 34 includes one or more notches 35 formed therein, to partially receive the upper portions 12 of the binding rings or members 11. The file folder 20 may further include an aperture 37 formed therein, such as formed in the coupling strip 33 and the outer flap 34, and an ear 36 extended from the cover panel 21, and to be aligned with the aperture 37 of the coupling strip 33 and the outer flap 34, to allow the file folder 20 to be easily opened with the ear 36 by the users (FIGS. 13, 14).

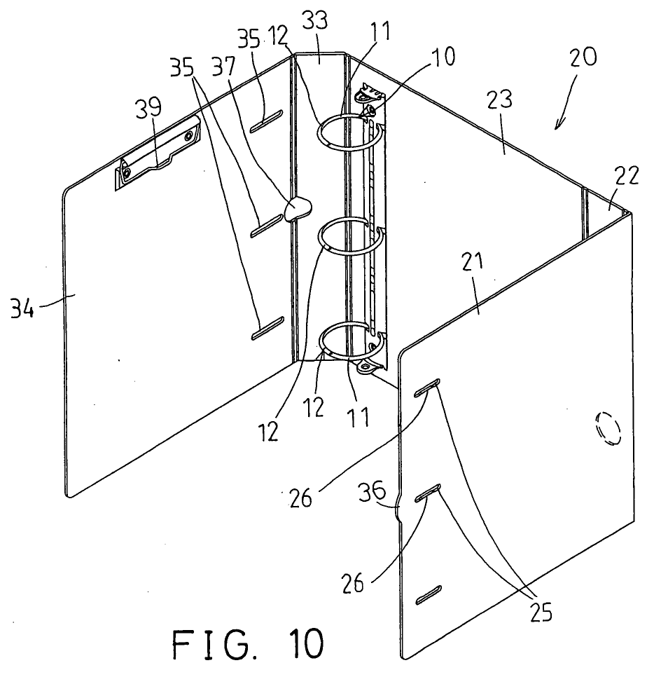

As shown in FIGS. 10-14, illustrated is a still further embodiment of the file folder 20, in which the outer flap 34 may include a width or length greater than that of the outer flap 34 as shown in FIGS. 8-9, and may further include a clip 39 attached thereto, for attaching or retaining the other sheet members (not shown) to the file folder 20.

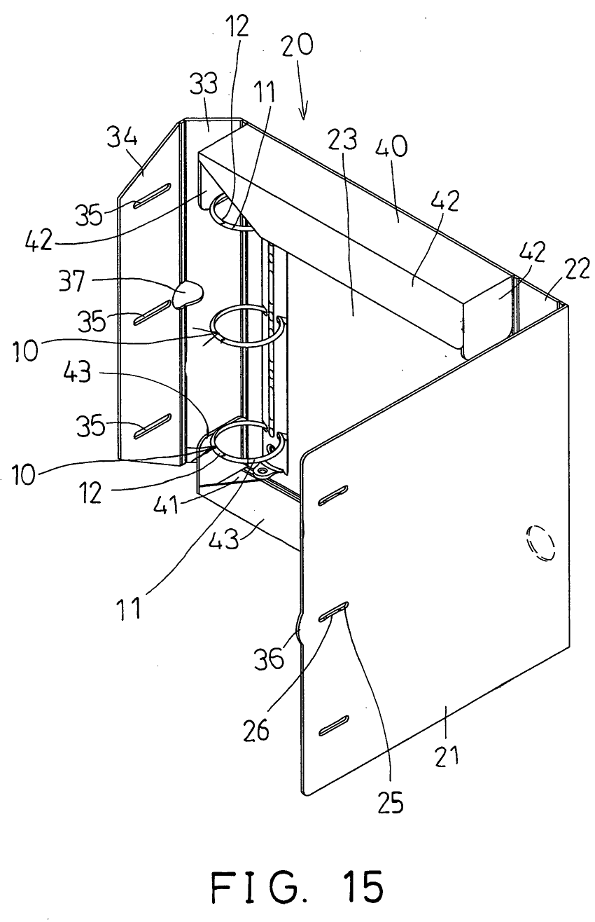

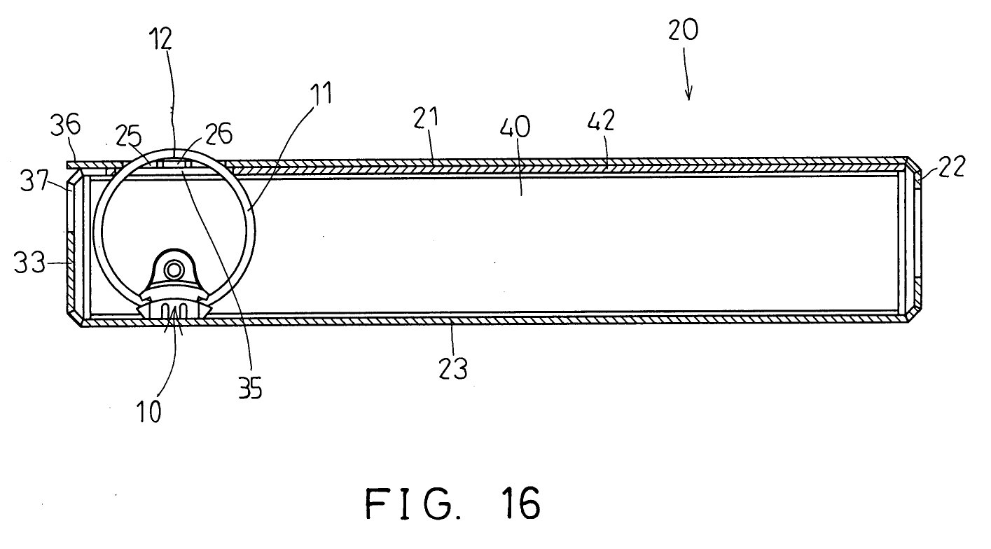

As shown in FIGS. 15-16, illustrated is a still further embodiment of the file folder 20, in which the base panel 23 may further include one or more bars 40, 41 attached or foldably or pivotally coupled to the upper and/or the lower portion thereof, and each of the bars 40, 41 includes one or more foldable flanges 42, 43 foldable relative to the bars 40, 41 respectively, to stably receive and retain the sheet members (not shown) within the file folder 20.

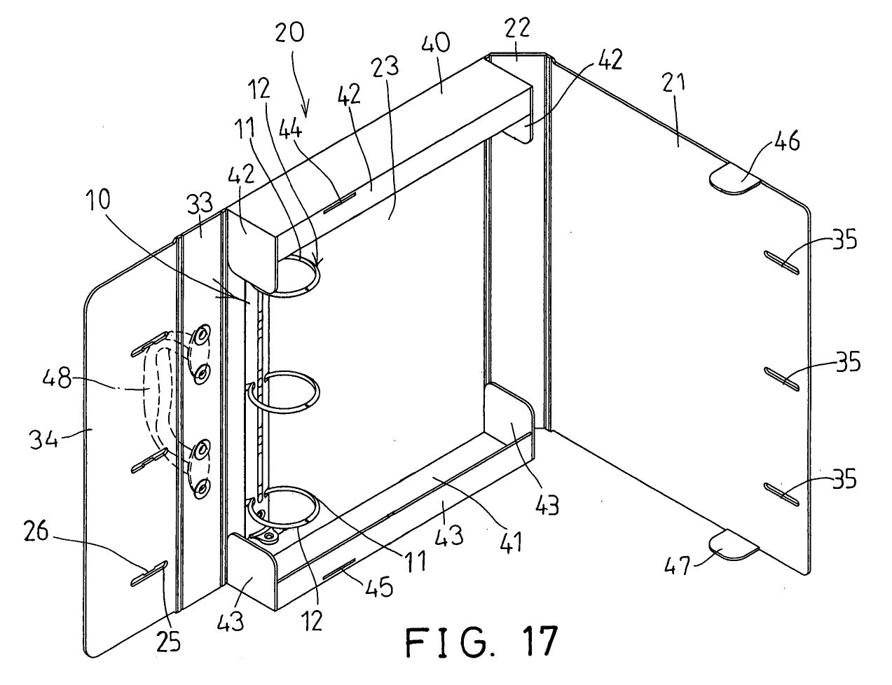

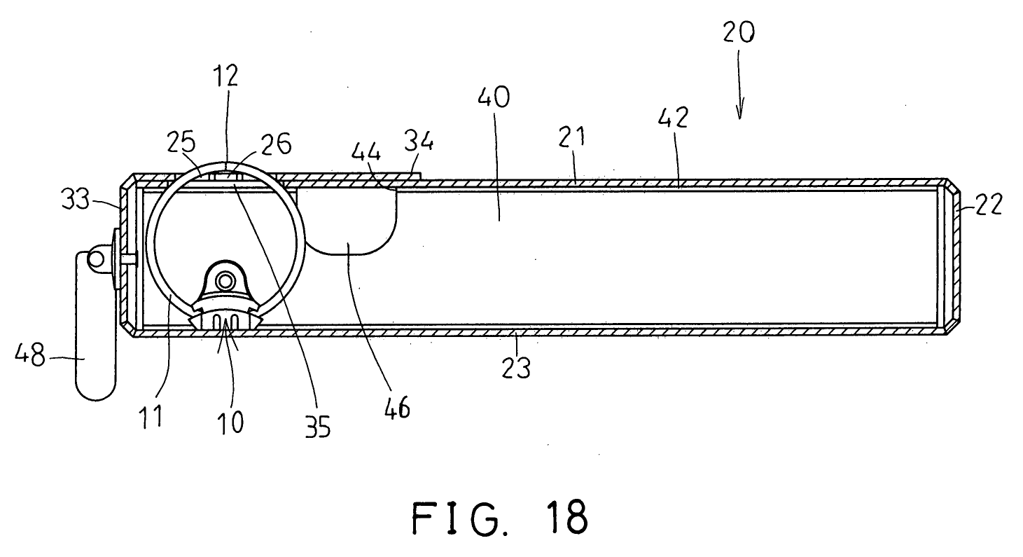

As shown in FIGS. 17-18, illustrated is a still further embodiment of the file folder 20, in which each of the bars 40, 41 further includes a groove 44, 45 formed therein, or formed in either of the foldable flanges 42, 43, and the cover panel 21 may include one or more protrusions 46, 47 extended therefrom and engageable into the corresponding grooves 44, 45 of the bars 40, 41, to stably attach or anchor the cover panel 21 to the base panel 23, and to further stably receive and retain the sheet members (not shown) within the file folder 20. The file folder 20 may further include a handle 48 attached thereto, for easily carrying the file folder 20.

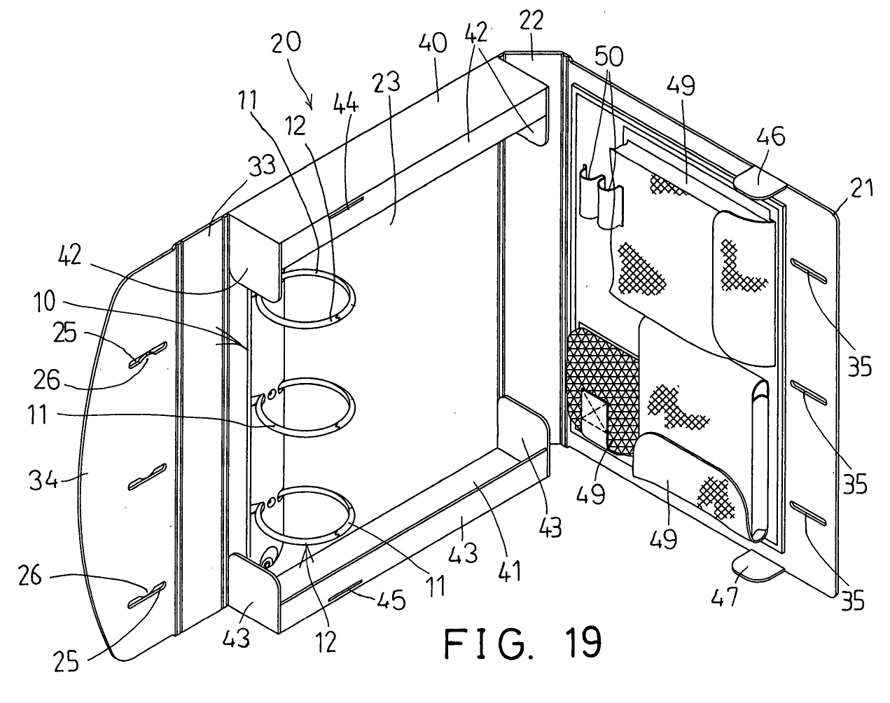

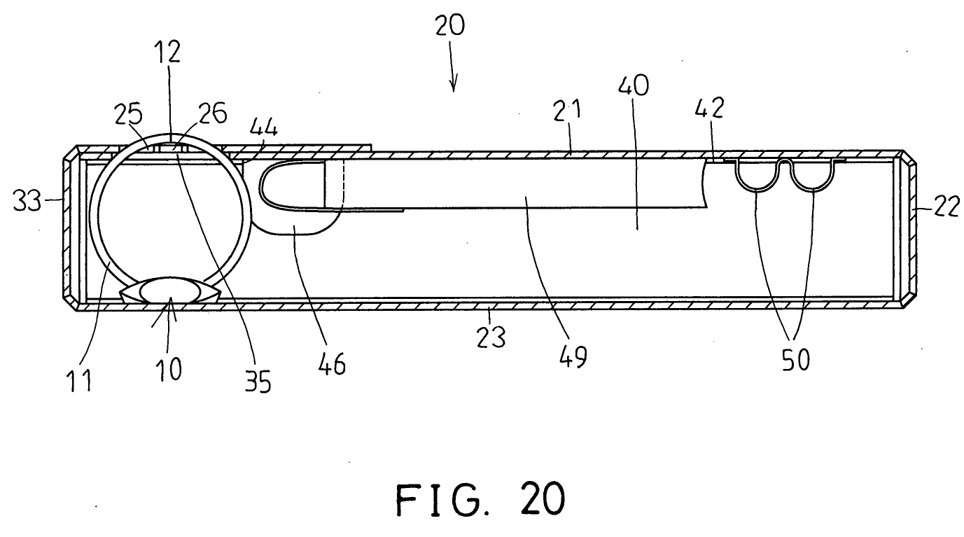

As shown in FIGS. 19-20, illustrated is a still further embodiment of the file folder 20, in which the file folder 20 may further include one or more pockets 49 attached to such as the cover panel 21, and/or one or more loops 50 attached to such as the cover panel 21, for receiving the other objects (not shown).

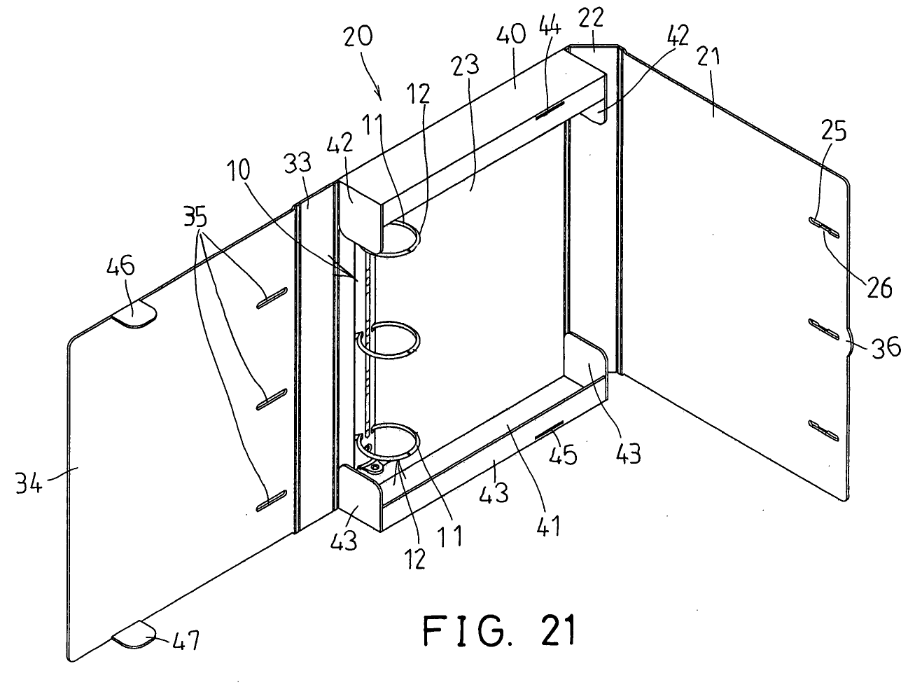

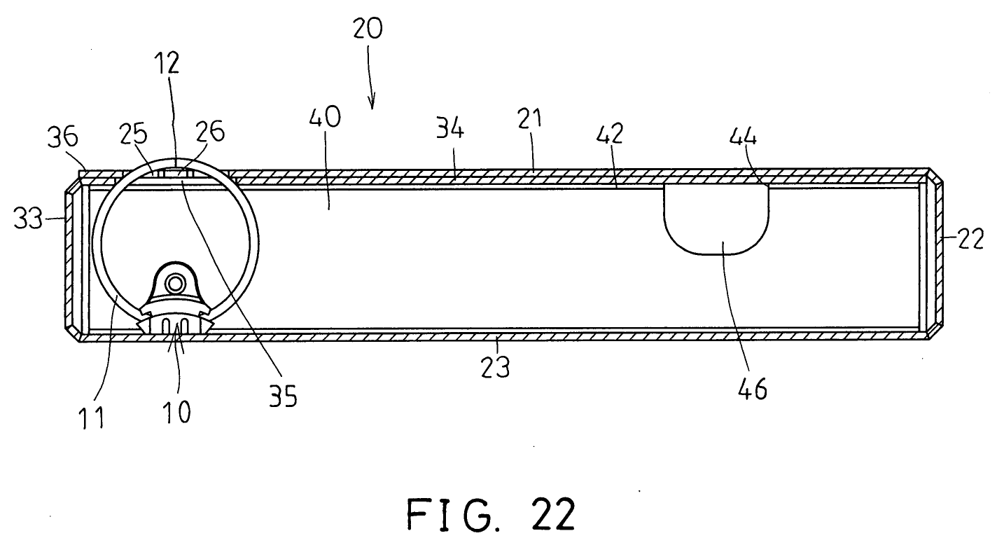

As shown in FIGS. 21-22, illustrated is a still further embodiment of the file folder 20, in which the outer flap 34 may include a width or length greater than that of the outer flap 34 as shown in FIGS. 8-9, 15-19, and may further include one or more protrusions 46, 47 extended therefrom and engageable into the corresponding grooves 44, 45 of the bars 40, 41, to stably attach or anchor the outer flap 34 to the base panel 23, and to further stably receive and retain the sheet members (not shown) within the file folder 20.

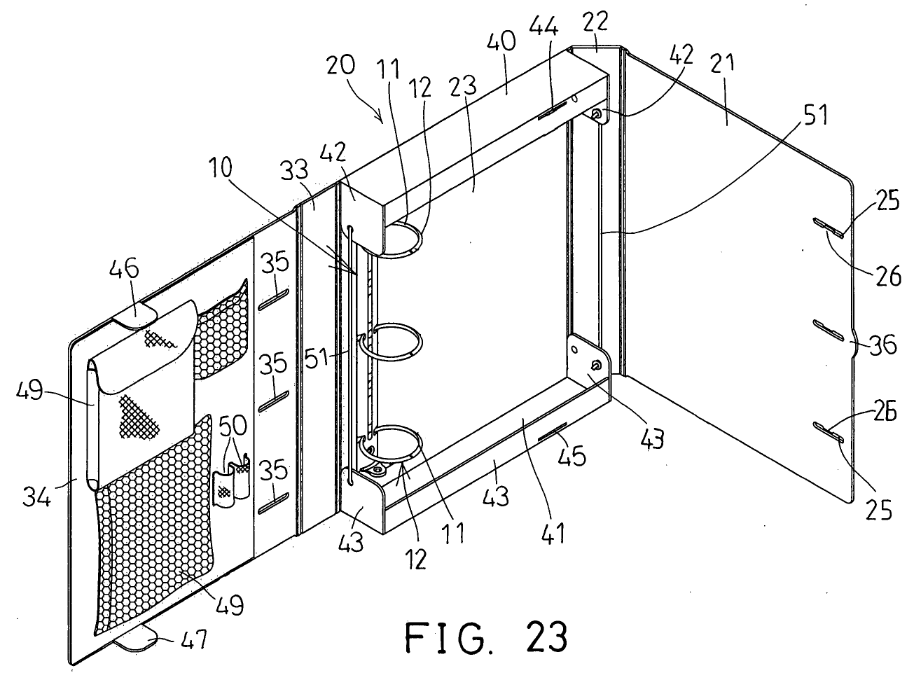

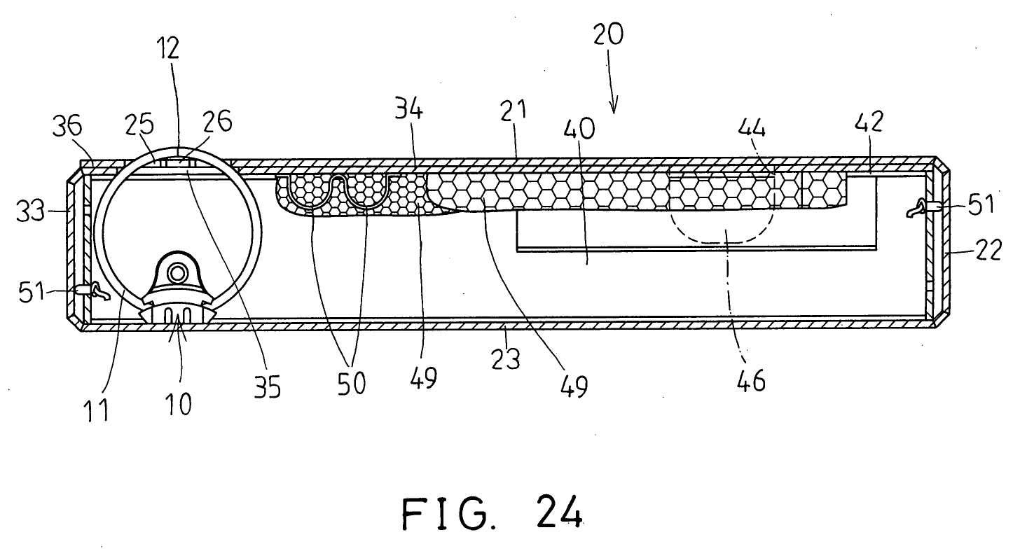

As shown in FIGS. 23-24, illustrated is a still further embodiment of the file folder 20, in which the file folder 20 may further include one or more pockets 49 attached to such as the outer flap 34, and/or one or more loops 50 attached to such as the outer flap 34, for receiving the other objects (not shown), and may further include one or more coupling cables or ropes 51 coupled between the bars 40, 41 or the foldable flanges 42, 43 of the bars 40, 41 respectively, to couple the bars 40, 41 together, and to prevent the bars 40, 41 from folded outwardly inadvertently.

Accordingly, the file folder in accordance with the present invention includes a retaining or locking device to detachably retaining or locking the cover panel to the base panel of the file folder, and to prevent the cover panel from being opened relative the base panel inadvertently.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

1. A file folder comprising:
a cover panel including at least one notch formed therein,
a base panel,
a coupling panel disposed between and foldably coupled between said cover panel and said base panel, to allow said base panel and said cover panel to be folded relative to said coupling panel, and
a binder device attached to said base panel, and including at least one binding member provided thereon, said at least one binding member include an upper portion extendible into said at least one notch of said cover panel, and engageable with said cover panel, to sustain said cover panel relative to said base panel.

2. The file folder as claimed in claim 1, wherein said cover panel includes a projection extended into said at least one notch of said cover panel, and engageable into said at least one binding member, to anchor said at least one binding member to said cover panel, and to openably retain said cover panel to said base panel.

3. The file folder as claimed in claim 1, wherein said cover panel includes a first flap foldably extended from a free edge thereof, and having at least one opening formed therein for carrying purposes.

4. The file folder as claimed in claim 3, wherein said first flap includes at least one fastener attached thereto.

5. The file folder as claimed in claim 4, wherein said base panel includes a second flap foldably extended from a free edge thereof, and having at least one opening formed therein for carrying purposes, said second flap is superposeable with said first flap.

6. The file folder as claimed in claim 5, wherein said second flap includes at least one fastener attached thereto and engageable with said at least one fastener of said first flap, to detachably secure said first flap and said second flap together.

7. The file folder as claimed in claim 5, wherein said second flap includes at least one second opening formed therein for hanging purposes.

8. The file folder as claimed in claim 3, wherein said first flap includes at least one second opening formed therein for hanging purposes.

9. The file folder as claimed in claim 1, wherein said coupling panel includes at least one orifice formed therein for carrying purposes.

10. The file folder as claimed in claim 1, wherein said base panel includes a coupling strip and an outer flap foldably extended from a free edge thereof.

11. The file folder as claimed in claim 10, wherein said outer flap includes at least one notch formed therein, to partially receive said upper portion of said at least one binding members.
